(19) United States
(12) Patent Application Publication
(10) Pub. No.: US 2020/0351999 A1
(43) Pub. Date: Nov. 5, 2020

(54) APPARATUS AND METHOD FOR MONITORING A CIRCUIT

(71) Applicant: SIGNIFY HOLDING B.V., EINDHOVEN (NL)

(72) Inventor: HONG CHEN, EINDHOVEN (NL)

(21) Appl. No.: 16/766,505

(22) PCT Filed: Nov. 15, 2018
(86) PCT No.: PCT/EP2018/081429

§ 371 Date: May 22, 2020

(30) Foreign Application Priority Data
Nov. 28, 2017 (CN) PCT/CN2017/113427
Feb. 8, 2018 (EP) 18155673.9

(51) Int. Cl. H05B 45/375; H05B 45/325

(52) U.S. Cl. CPC H05B 45/375; H05B 45/50; H05B 45/325

(57) ABSTRACT

An apparatus is provided for monitoring a circuit, in which changes in relative timing between transitions in the signals at two circuit locations are identified, thereby to identify changes in characteristics of the circuit. The signals at the two circuit locations are sampled, a plurality of times, to generate first and second sampled signals, and the first and second sampled signals are compared to identify the changes in characteristics of the circuit. The apparatus may for example be used to monitor a transistor having a gate driven by a pulse width modulation circuit. Changes in relative timing between transitions at the pulse width modulation circuit output and at a transistor terminal are used to identify changes in characteristics of the transistor. This avoids the need for accurate timing measurements since it is based instead on instantaneous measurements of status values at multiple times. No accurate timing is needed between the measurements, and indeed the actual timing may be random.

### FIELD OF THE INVENTION

This invention relates to an apparatus and method for monitoring a circuit, for example a circuit which includes a power MOSFET.

### BACKGROUND OF THE INVENTION

In general, circuits perform a transformation function between an input and an output. This transformation function will change if the circuit characteristics alter, for example as a result of component ageing or failure. Within such circuits, transistors are widely used to implement a local function somewhere in the path between the input and the output of the overall circuit. This local function may be critical to the overall circuit operation.

The control of a transistor using pulse width modulation is also widely used. It enables a digital signal to be applied to the transistor to implement an analogue control function (for example because the high switching speed of the digital signal is effectively filtered out).

The power transistor (such as a power MOSFET) is for example a critical component in a switch mode power supply for example as used in an LED driver. Power transistors operate in tough working conditions, with high frequency and high power. There is also a need for very strong component reliability. Considering the catastrophic results which may be caused by transistor failure, it is well known to monitor the health status of transistors during circuit operation.

Unfortunately, there is no effective method to perform real time evaluation of the health status of a transistor. Known approaches are for example based on measuring the temperature and voltage conditions, but this approach is not sufficiently reliable. The temperature and voltage are not unique indicators of the transistor performance, but they are the result of the performance characteristics of the transistor and many other factors. Thus, it is not straightforward to indicate the health status of a transistor reliably based on temperature and voltage.

To make sure the transistor is operated in a safe area, design engineers have to use high rated components to provide a large design margin, and verify the performance in reliability tests. This is costly in both money and time. This issue applies generally to circuit design and is not specific to transistor circuits.

There is therefore a need for a monitoring circuit and method which can be used in real time to evaluate the performance of a circuit such as a circuit having a transistor, wherein the circuit may suffer changes in component characteristics. The monitoring for example means that a warning may be provided before catastrophic failure.

### SUMMARY OF THE INVENTION

The invention is defined by the claims.

It is a concept of the invention to monitor changes in the timing of signals within a circuit, and in particular by comparing signals at two circuit locations, wherein the circuit function between those two circuit locations may have a variable delay. These timing changes are caused by changes in the circuit characteristics.

According to examples in accordance with an aspect of the invention, there is provided an apparatus for monitoring a circuit, comprising:

a first input adapted to receive a first signal from the circuit;

a second input adapted to receive a second signal from the circuit, the second signal originating from a place in the circuit different to a place of the first signal;

a controller adapted to determine changes in relative timing between transitions in the signals at the first input and the second input thereby to identify changes in characteristics of the circuit;

wherein the controller is adapted to

sample, a plurality of times, the signals at the first input and the second input to generate first and second sampled signals;

compare the first and second sampled signals; and

identify changes in characteristics of the circuit based on the comparison results.

This monitoring circuit is used to determine timing differences (and in particular changes in those timing differences) which result from the delay which exists between two circuit locations. Changes in this delay can be used to identify changes in the characteristics of the circuit. This may for example enable a warning to be provided before circuit breakdown or other failure. The changes in characteristics are determined by comparing sampled signals from the first and second inputs. The comparison results depend on a time delay which is caused by the circuit (between the signals at the first and second inputs), but this time delay does not need to be measured by a timer.

The controller may be adapted to:

count the occurrence of particular values for the pair of first and second sampled signals over a time window; and

identify changes in characteristics of the circuit based on the count.

This approach involves counting occurrences of particular pairs of values. For example for binary signals, the two values will be different when the signal at the first input is out of sync with the signal at the second input as a result of a delay between transitions in the two signals. This delay is a characteristic of the circuit being monitored (for example a delay between an ideal transistor gate signal and the actual gate signal arriving at the gate and hence also propagating to the transistor output). If the count for a given time window changes, it means the delay has changed. By simply counting occurrences of particular value pairs, accurate timers are not needed.

The sampled signal values may comprise binary values and the particular values which are counted comprise:

01 and/or 10; or

00 and/or 11.

If the signals on the first and second inputs are normally the same, and any difference is indicative of a delay, then the 01 and/or 10 values are monitored. If the signals on the first and second inputs are normally inverted versions of each other, and any occasion when they are both the same is indicative of a delay, then the 00 and/or 11 values are monitored.

It is assumed that the first value of the pair is for the first input and the second value of the pair is for the second input.

For the case where the signals at the two inputs are meant to be the same, the 01 signal indicates that there is a delay in the signal at the second input dropping from 1 to 0 and the 10 signal indicates that there is a delay in the signal at the second input rising from 0 to 1.

For the case where the signals at the two inputs are meant to be inverted, the 00 signal indicates that there is a delay in the signal at the second input rising from 0 to 1 and the 11 signal indicates that there is a delay in the signal at the second input dropping from 1 to 0.

By using a sampling approach, no measurement of actual delay is needed, and the analysis is instead based on a statistical approach, by which a count value is representative of the actual delay.

The resolution of the analysis is thus not time-based but is relative to the time between transitions in the two signals.

The controller may be adapted to:

derive a probability of the particular values; and

identify changes in characteristics of the circuit based on the probability.

The count value may thus be used to represent a probability (which in turn is equivalent to a time fraction during which the undesired signal pairs are present, which in turn is equivalent to a time delay).

The time window may comprise at least 1000 samples, for example at least 5000 samples and/or the time window may comprise at least 100 period of the signals at the first and second inputs.

A statistical approach over a large number of samples for a large number of signal pulses enables small changes in circuit performance to be identified, which correspond to small changes in circuit characteristics.

The controller may be adapted to perform the sampling at random or pseudo-random time instants.

By using random sampling, it is ensured that the timing of the sampling instants is not synchronized with the timing of the signals on the first and second inputs.

The apparatus may further comprise a voltage divider between one or both of the first and second inputs and the controller. This is used to enable the two signals to be compared in a binary manner, i.e. to generate inputs suitable for a comparator.

The apparatus is for example for monitoring a circuit which comprises a switch mode semiconductor device like a transistor, wherein the gate of the transistor is driven by a pulse width modulation circuit through a gate driver circuit, wherein:

the first input is adapted to receive the output of the pulse width modulation circuit; and

the second input is adapted to receive the signal at a terminal of the transistor.

This monitoring circuit is used to determine timing differences (and in particular changes in those timing differences) which result from the delay caused by the gate driver and optionally also the transistor itself. The pulse width modulation circuit delivers an ideal gate voltage, but after passing through the gate driver and optionally also through the transistor, an imperfect gate voltage arrives at the transistor gate or an imperfect output signal arrives at the transistor output. This imperfection is the result of the combined effect of the gate driver itself and also the characteristics of the transistor. Thus, changes in the relative timing can be used to identify changes in the transistor characteristics. This may for example enable a warning to be provided before transistor breakdown or other failure.

In one example, the second input is adapted to receive the output of the gate driver circuit at the gate of the transistor. This example enables monitoring only at the input side of the transistor and is thus simple to implement.

In another example, the transistor has an input and an output, with the coupling between the input and output controlled by the gate, and wherein the second input is adapted to receive the signal at the output of the transistor. This provides monitoring at the output (e.g. the source of a MOSFET) of the transistor.

In both cases, the invention does not require accurate determination of actual delay values so does not require accurate timing measurements.

The invention also provides a transistor circuit comprising:

a transistor having a gate;

a pulse width modulation circuit for providing a drive signal to the gate of the transistor through a gate driver circuit; and

a monitoring apparatus as defined above for monitoring the transistor, wherein the first input is coupled to the output of the pulse width modulation circuit and the second input is coupled to a terminal of the transistor.

This transistor circuit includes a monitoring circuit for monitoring the health of the transistor. The transistor is for example a power transistor (which for example implies a power rating of greater than 10 Watts) such as a power MOSFET.

The invention also provides a switch mode power supply, comprising:

an energy storage unit; and

a transistor circuit as defined above for controlling the transfer of energy from a power supply input to the energy storage unit and from the energy storage unit to an output load.

The switch mode power supply may be any type of converter, such as a buck converter, boost converter, or buck-boost converter. The energy storage unit may be an inductor or capacitor. Switch mode power supplies are used widely in high power electronic circuits.

The invention also provides an LED lighting driver comprising:

a switch mode power supply as define above; and

a controller for controlling the pulse width modulation circuit of the transistor circuit.

The invention also provides a lighting circuit comprising:

an LED lighting driver as defined above; and

an LED arrangement driven by the LED lighting driver.

The invention thus enables real time transistor monitoring in a switch mode power supply, for example as used in an LED lighting driver.

The invention also provides a method for monitoring a circuit, comprising:

receiving a first signal from the circuit;

receiving a second signal from the circuit, the second signal originating from a place in the circuit different to a place of the first signal; and

determining changes in relative timing between transitions in the first signal and the second signal thereby to identify changes in characteristics of the circuit,

wherein the determining changes comprises:

sampling, a plurality of times, the first and second signals to generate first and second sampled signals;

comparing the first and second sampled signals; and

identifying changes in characteristics of the circuit based on the comparison results.

This monitoring method determines timing differences which result from the delay caused by a circuit. This delay correlates with changes in the circuit characteristics.

The method may comprise:

counting the occurrence of particular values for the pair of first and second sampled signals over a time window; and

identifying changes in characteristics of the circuit based on the count.

The method may comprise:

deriving a probability of the particular values; and

identifying changes in characteristics of the circuit based on the probability.

The time window for example comprises at least 1000 samples, for example at least 5000 samples and/or at least 100 periods of the first and second signals.

The sampling is for example performed at random or pseudo-random time instants.

The invention may be implemented at least in part in software.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows an LED driver;

FIG. 2 shows the driver circuit of FIG. 1 in more detail;

FIG. 3 shows an equivalent circuit representing the various parasitic resistances and capacitances of the transistor and gate driver;

FIG. 4 shows the operation of the circuit; and

FIG. 5 shows method for monitoring a transistor.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an apparatus for monitoring a circuit, in which changes in relative timing between transitions in the signals at two circuit locations are identified, thereby to identify changes in characteristics of the circuit. The signals at the two circuit locations are sampled, a plurality of times, to generate first and second sampled signals, and the first and second sampled signals are compared to identify the changes in characteristics of the circuit. The apparatus may for example be used to monitor a transistor having a gate driven by a pulse width modulation circuit. Changes in relative timing between transitions at the pulse width modulation circuit output and at a transistor terminal are used to identify changes in characteristics of the transistor. This avoids the need for accurate timing measurements since it is based instead on instantaneous measurements of status values at multiple times. No accurate timing is needed between the measurements, and indeed the actual timing may be random.

The invention relates generally to the monitoring of a circuit, in particular in which the circuit has a transfer function by which an input signal (e.g. a binary signal) is routed to the output, with a delay or with a pulse edge shaping which depends on the characteristics of the circuit. The signal which is routed to the output may be an inverted version of the signal at the input or a non-inverted version. The delay or edge shaping varies in dependence on the ageing or other changes in the circuit characteristics, so that monitoring changes in this delay can be used as an indicator of circuit degradation, damage, ageing or end-of-life.

The invention is described below in connection with one preferred application, in which the circuit is for monitoring of a transistor circuit, in particular in which the transistor has a gate drive signal which is in the form of a pulse width modulation signal. The invention will furthermore be described with reference to one preferred application of the invention, within an LED driver.

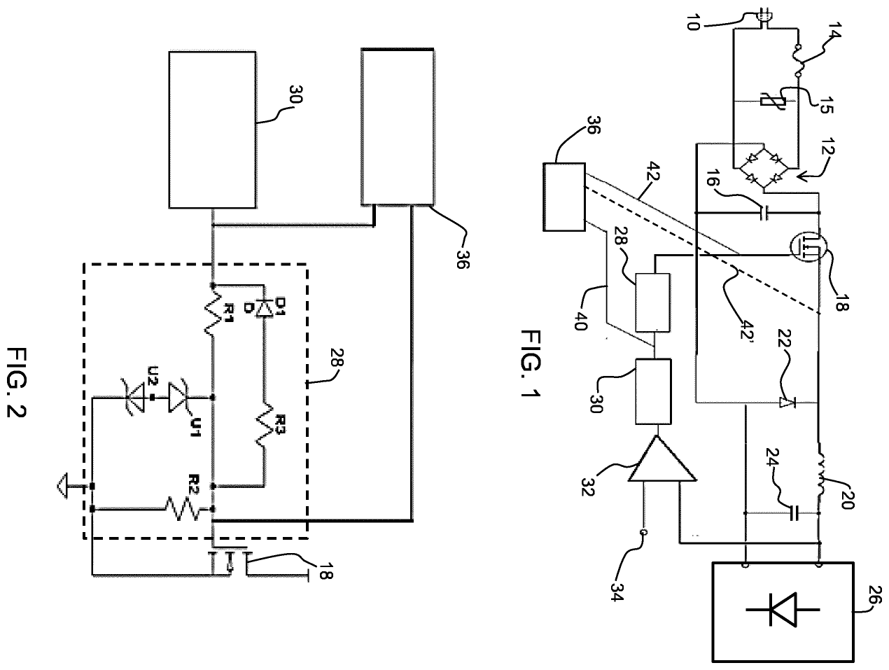

FIG. 1 shows an LED driver, comprising a mains input 10 which supplies a diode bridge rectifier 12 through a fuse 14. A metal oxide varistor 15 is used to suppress (absorb) any surge current at the AC or DC input.

The output of the rectifier is stored across a smoothing capacitor 16 and provided to one main terminal (source or drain) of the power transistor 18. The other main terminal connects to an energy storage device in the form of an inductor 20 in this example as well as a flyback diode 22. An output capacitor 24 is provided in parallel with the output load 26 which in this example is an LED arrangement.

The transistor 18 has an input at the output of the rectifier (e.g. the drain) and an output (e.g. the source) which is coupled to the energy storage device, with the coupling between the drain and source (i.e. the state of conduction of the transistor) controlled by the gate.

The transistor 18, inductor 20, diode 22 and output capacitor 24 function as a buck converter. The transistor is operated with a duty cycle to alter the charging and discharging phases of the circuit and thereby alter the conversion ratio.

There are other possible switch mode power converters that use a main switching transistor which is controlled with a pulse width modulation signal, such as a boost converter, or a buck-boost converter.

The gate of the transistor 18 is provided with a signal generated by a gate driver circuit 28. An input to the gate driver circuit is provided by a pulse width modulation circuit (oscillator) 30. The duty cycle of the pulse width modulation signal is controlled by feedback, for example based on the output voltage at the load. This provides a regulated output voltage. Equally, the output current may be regulated. FIG. 1 shows a generic feedback comparator 32 for comparing an output signal with a reference 34. The comparator 32 functions as a controller for controlling the pulse width modulation circuit. It may be more complicated than a simple comparator as shown and for example include a control integrated circuit.

To the extent described above, the circuit is conventional.

The invention is implemented by a controller 36. It has a first input 40 which receives the output of the pulse width modulation circuit 30 and a second input 42 which receives the signal at a terminal of the transistor. In this way, the influence of the transistor characteristics on the previously ideal pulse width modulation signal can be detected.

FIG. 1 shows two possible implementations. A first implementation is based on the controller receiving the output of the gate driver circuit 28, i.e. the signal at the gate of the transistor 18. This is shown as the solid line 42. An alternative approach is to use the signal at the output of the transistor, for example the source (although it could equally be the drain, depending on the transistor type and connection). This alternative is shown as the dotted line 42′.

The controller determines changes in relative timing between transitions in the signals at the first input 40 and the second input 42 thereby to identify changes in characteristics of the transistor 18.

The controller 36 may be an existing controller of an LED driver in which case the invention may be implemented only as a change to the driver software. Alternatively, a dedicated controller may be provided.

FIG. 2 shows the driver circuit 28 in more detail. It is used to transfer the PWM signal from the PWM circuit 30 to the transistor 18 for better on/off control. Essentially, it comprises a level shifting resistor divider circuit (resistors R1, R2) with Zener diodes U1 and U2 for threshold setting and a pull down resistor-diode arrangement R3, Dl.

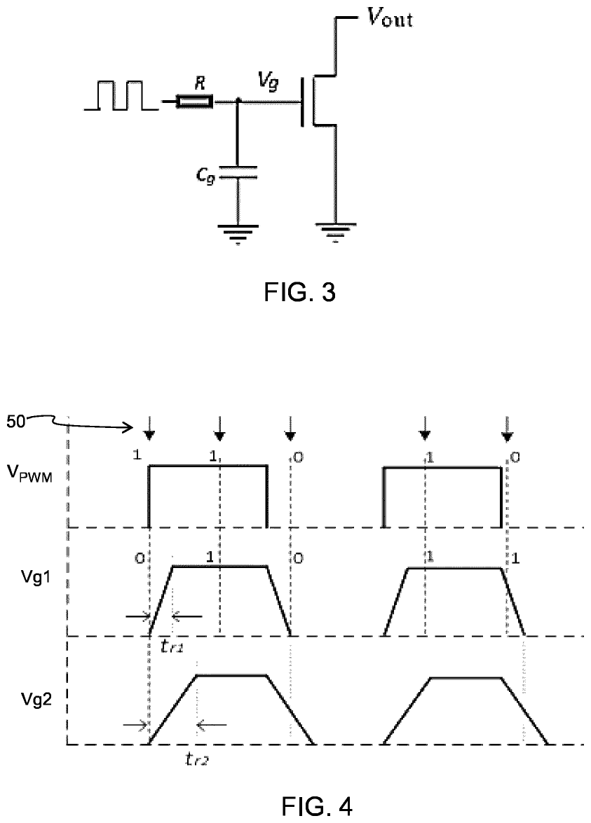

The transistor 18 has stray capacitances, typically ranging from hundreds of pico farads to tens of nano farads, depending on the transistor design. The various parasitic resistances and capacitances may be represented by the equivalent circuit of FIG. 3 in which there is a series gate resistance R and a parallel gate capacitance Cg.

The series gate resistance R is the combination of a resistance Rd representing the driver circuit 28 and the actual gate resistance Rg of the transistor. The capacitance Cg is the total input capacitance of the transistor. Rg and Cg are the essential parameters of the transistor, and any change in transistor characteristics will impact these two parameters. By observing the variance of Rg and Cg, a status change of the transistor may be determined. However, it is challenging to measure these parameters in real time with high precision.

The invention is based on the recognition that the RC network of FIG. 3 will impact the signal phase when a pulse signal passes through the RC network, and these changes in signal phase may be used as indicators of changes in characteristics of the transistor. This phase lag is determined precisely by the RC value. Thus, a change in RC value will have different phase impact for the signal being processed. Thus, a relationship exists between the status of the transistor and a signal phase shift.

The PWM circuit generates the PWM signal using a dedicated integrated circuit, and it has an ideal square waveform which has sharp rising edges and falling edges. When this PWM signal passes through the RC network equivalent circuit, the signal is changed slightly in its rising edge and falling edge. By comparing the signal before and after the RC network, the variance of the gate resistance and gate capacitance, Rg and Cg, in the transistor is observed, when the resistance Rd is fixed.

The controller 36 reads the signals at the two inputs (which together form part of an I/O port) at random times to detect the status of the two pins shown, in binary manner. Each input thus has either a status “1” or “0”. The read operation of the controller is random so that it is not synchronized with the periodic PWM signal. In this way, all possible combinations of status of the pins is derived, because the read operation may take place at any phase of the PWM signal.

FIG. 4 shows the operation of the circuit, and is based in particular on the use of the transistor gate for the second input.

The top plot 50 shows as a set of arrows the timing instants at which the controller 36 reads the signals on the two inputs. The controller may simply make a binary decision based on a threshold level with which the signal is compared. The threshold level may be mid way between the voltage rails, but this is not essential. As long as the same metric is used to distinguish between a 1 and a 0 each time, the threshold does not matter, because it is only changes in relative timing that are of interest.

The second plot shows the input to the controller received from the pulse width modulator circuit 30, V_{PWM}.

The third plot shows the input to the controller received from the transistor gate, Vg1, when the transistor has a first set of characteristics.

The fourth plot shows the input to the controller received from the transistor gate, Vg2, when the transistor has a second set of characteristics.

The signal V_{PWM} is an ideal pulse signal with sharp edges. It functions as a reference signal in this method.

The gate capacitance Cg for example increases from Cg1 to Cg2 due to transistor decay as between the third and fourth plots. The rising edges and falling edges change as shown.

The controller 36 reads four possible pairs of signals, namely 10, 11, 00, and 01. The phase lag causes some of the read signals to change. In particular, the signals “10” and “01” are strongly related to the rise time delay caused by the RC equivalent circuit. For the five timing instants shown, the readings are:

### Vg1: 10 11 00 11 01

### Vg2: 10 11 01 11 01

Thus, it can be seen that the delay has caused one additional occurrence of a 01 value.

If the controller is run for a given time period the probability of a “10” or a “01” can be derived. For example, the controller may read 10,000 times the status of the two pins. The value “10” may happen 50 times. In a subsequent analysis the number of “10” values may change to 60. This is representative of a change in the Rg and Cg value of the transistor. Larger value of Rg and/or Cg give rise to increased switching loss, and there may then be a higher thermal risk, which may be catastrophic for the transistor.

In this way, real-time monitoring of the transistor performance is possible and an alarm may be provided. In addition, since no complicated hardware is needed the solution is low cost with high reliability.

The method may be based on counting 01 values or 10 values or both. These arise when the ideal gate signal is out of sync with the actual gate signal arriving at the gate. If the count (for a given time window) changes, it means the delay has changed. By simply counting occurrences of word values, accurate timers are not needed.

The 01 signal for example indicates that there is a delay in the actual gate signal dropping from 1 to 0 and the 10 signal indicates that there is a delay in the actual gate signal rising from 0 to 1. No measurement of the actual delay is needed, and the analysis is instead based on a statistical approach, by which a count value is representative of the actual delay.

By way of example, 5000 samples may be taken randomly in a 5 second window for a 50 kHz PWM signal. More generally, the time window for example comprises at least 1000 samples and it may comprise at least 100 pulse width modulation signal periods.

As mentioned above, the example waveforms of FIG. 4 are based on the connection 42 of FIG. 1, but the same approach may be applied using the connection 42′ to the transistor source. In the latter case, the transistor output voltage is typically much higher than the gate voltage, so that a voltage divider may be used in the controller 36 so that the signals can again be compared. There may be a voltage divider associated with one or both of the inputs to the controller.

The example above is based on a circuit in which the signal at the second input (i.e. the local circuit output) is meant to follow the signal at the first input (i.e. the local circuit input). Thus, the local circuit part being monitored (i.e. the transistor) has a pass through transfer characteristic. They may instead be inverted versions of each other if the local circuit part being monitored has an inverting transfer characteristic. In this case, 00 and/or 11 values may be monitored. The 00 signal indicates that there is a delay in the signal at the second input rising from 0 to 1 and the 11 signal indicates that there is a delay in the signal at the second input dropping from 1 to 0.

Thus, more generally, a particular pair of sampled values is monitored or indeed a particular set of pairs of sampled values (such as 01, 10, 01 and 10, 00, 11, or 00 and 11). The values to be monitored depend on the application and circuit function.

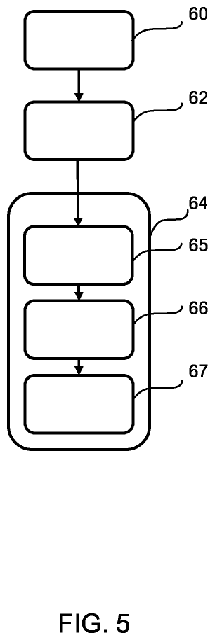

FIG. 5 shows method for monitoring a circuit, comprising:

(60) receiving a first signal from the circuit;

(62) receiving a second signal from the circuit, the second signal originating from a place in the circuit different to a place of the first signal; and

(64) determining changes in relative timing between transitions in the first signal and the second signal thereby to identify changes in characteristics of the circuit.

Determining changes comprises:

(65) sampling, a plurality of times, the first and second signals to generate first and second sampled signals;

(66) comparing the first and second sampled signals; and

(67) identifying changes in characteristics of the circuit based on the comparison results.

The circuit is for example a transistor circuit, in which the gate of the transistor is driven using a pulse width modulation circuit through a gate driver circuit. The first signal is then received from the output of the pulse width modulation circuit and the second signal is received from a terminal of the transistor, for example the output of the gate driver circuit at the gate of the transistor, or an output terminal of the transistor.

As discussed above, embodiments make use of a controller. The controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

The invention may be applied to the monitoring of any circuit in which a change in transfer function is to be monitored. The first and second inputs which are monitored may connect to any pair of circuit nodes where a fixed relationship is normally expected between the signals (such as a fixed delay or inversion with a fixed delay). The first and second inputs may for example be at the input and the output of a single critical component with a larger overall circuit (such as a transistor as in the example above) or it may be at the input and output of an arrangement of multiple components.

The invention is of particular interest for a transistor operated using duty cycle control of its gate signal. The PWM signal which defines the duty cycle for example has a switching frequency in the kHz range, for example 1 kHz to 1 MHz. The transistor may form part of any circuit, most typically with a low pass filter implemented at the output to smooth the high frequency ripple so that the digital PWM control is used to implement an essentially analog output function. This is the case for switch mode power supplies or switch mode power converters but there are other circuits in which such a function is used.

The invention is of particular interest for power transistors, e.g. with an operating power greater than 10 W. The consequent heating in such devices gives increased risk of thermal breakdown or shock, which can be prevented by the monitoring described above.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A transistor circuit comprising:
a transistor (18) having a gate;
a gate driver circuit;
a pulse width modulation circuit for providing a drive signal to the gate of the transistor through the gate driver circuit; and
an apparatus for monitoring the transistor circuit, comprising:
a first input coupled to the output of the pulse width modulation circuit adapted to receive a first signal from the transistor circuit;
a second input coupled to a terminal of the transistor adapted to receive a second signal from the transistor circuit, the second signal originating from a place in the transistor circuit different to a place of the first signal;
a controller adapted to determine changes in relative timing between transitions in the signals at the first input and transitions in the signals at the second input respectively thereby to identify changes in characteristics of the transistor circuit;
wherein the controller is adapted to:
sample, a plurality of times, the signals at the first input and the second input to generate first and second sampled signals;
compare the first and second sampled signals; and
identify changes in characteristics of the transistor circuit based on the comparison results.

2. A transistor circuit as claimed in claim 1, wherein the controller is adapted to:
count the occurrence of particular values for the pair of first and second sampled signals over a time window; and
identify changes in characteristics of the transistor circuit based on the count.

3. A transistor circuit as claimed in claim 2, wherein the sampled signal values comprise binary values and the particular values which are counted comprise:
01 and/or 10; or
00 and/or 11.

4. A transistor circuit as claimed in claim 2, wherein the controller is adapted to:
derive a probability of the particular values; and
identify changes in characteristics of the transistor circuit based on the probability.

5. A transistor circuit as claimed in claim 1, wherein the controller is adapted to perform the sampling at random or pseudo-random time instants.

6. A transistor circuit as claimed in claim 1, further comprising a voltage divider between one or both of the first and second inputs and the controller.

7. (canceled)

8. An apparatus as claimed in claim 1, wherein:
the second input is adapted to receive the output of the gate driver circuit at the gate of the transistor; or
the transistor has an input and an output, with the coupling between the input and output controlled by the gate, and wherein the second input is adapted to receive the signal at the output of the transistor.

9. (canceled)

10. A switch mode power supply, comprising:
an energy storage unit; and
a transistor circuit as claimed in claim 1 for controlling the transfer of energy from a power supply input to the energy storage unit and from the energy storage unit to an output load.

11. An LED lighting driver comprising:
a switch mode power supply as claimed in claim 10; and
a controller for controlling the pulse width modulation circuit of the transistor circuit.

12. A lighting circuit comprising:
an LED lighting driver as claimed in claim 11; and
an LED arrangement driven by the LED lighting driver.

13. A method for monitoring a transistor circuit,
the transistor circuit comprising
a transistor having a gate;
a gate driver circuit;
a pulse width modulation circuit for providing a drive signal to the gate of the transistor through the gate driver circuit;
wherein the method comprising:
receiving a first signal from the output of the pulse width modulation circuit;
receiving a second signal from a terminal of the transistor, the second signal originating from a place in the transistor circuit different to a place of the first signal; and
determining changes in relative timing between transitions in the first signal and the second signal thereby to identify changes in characteristics of the transistor circuit,
wherein the determining changes comprises:
sampling, a plurality of times, the first and second signals to generate first and second sampled signals;
comparing the first and second sampled signals; and
identifying changes in characteristics of the transistor circuit based on the comparison results.

14. A method as claimed in claim 13, comprising:
counting the occurrence of particular values for the pair of first and second sampled signals over a time window; and
identifying changes in characteristics of the transistor circuit based on the count.

15. A computer program comprising computer program code means which is adapted, when said program is run on a computer, to perform the method of claim 13.
